(19) United States
(12) Patent Application Publication
(10) Pub. No.: US 2010/0077891 A1
(43) Pub. Date: Apr. 1, 2010

(54) DISENGAGEMENT AND REMOVAL TOOL FOR SWOLLEN GLOW PLUG

(76) Inventors: Mohammed Abu-Alfaraj, Madina Monawara (SA); Mohammed Ali Al-Turky, Madina Monawara (SA)

Correspondence Address: NIXON & VANDERHYE, PC, 901 NORTH GLEBE ROAD, 11TH FLOOR, ARLINGTON, VA, 22203, US

(21) Appl. No.: 12/241,572

(22) Filed: Sep. 30, 2008

(51) Int. Cl. B25B 13/50

(52) U.S. Cl. 81/53.2

(57) ABSTRACT

Disengagement and removal tool consists of five metal parts, which can easily remove swollen glow plug without exposure to break and despite the narrow area between the engine and the body of the vehicle. This is done within approximately 60 minutes per vehicle, while the currently used tool takes from one day to one week to do this

### BACKGROUND OF THE INVENTION

The field of the invention is related to disengagement and removal tool for swollen glow plugs of diesel engines and hummer vehicles, wherein the plugs are fastened on the engine wall under the atomizer. When the engine runs, the glow plug exposes to high temperature, and with time swells inside the engine. When the plug is replaced by a new one through the currently used tool, which is a metal fork, the disengagement process becomes difficult firstly because of the glow plug swelling and secondly because of the narrow area that does not allow the metal fork to function effectively. Therefore, the disengagement process is time-consuming. Sometimes the swollen plug breaks inside the cylinder when it is removed by the metal fork. In this case it is required that the atomizer should be disengaged to try then to get out the plug through swelling. If this trial is failed, it is required that the head of the engine should be disengaged which means wasting more time and effort.

### SUMMARY OF THE INVENTION

In view of the above-mentioned disadvantages of the tool which is currently used to disengage and remove the swollen glow plug resulting in wastage of a lot of time and effort in trying to disengage it, the present invention overcomes all of these disadvantages and carries out the disengagement and removal process very easily and in a short time without breakage of the swollen glow plug inside the engine cylinder.

### BRIEF DESCRIPTION OF THE DRAWINGS

The idea of the invention and further advantages can be illustrated through the following detailed description and illustrative drawings in which:

FIG. 1 represents a main cylindrical object having an externally threaded front portion and L-shaped cut. The edge of the front portion is cut out in V-shape. The inside of it is hollowed in a form similar to that of the glow plug to mount it. There is also a semi-circular cutting in the externally threaded portion to fasten a metal ring. There is an opening at the rear portion of the figure to mount an automatic switch for engaging and disengaging process. See the measurements in FIG. 1-1.

FIG. 2 represents an externally threaded cylindrical object complementary to the main portion placed on the L-shaped portion. The edge of the front portion is cut out in V-shape. The inside of it is hollowed in the form of the glow plug to mount it. There is also a semi-circular cutting in the externally threaded portion to fasten a metal ring. See the measurements in FIG. 2-2.

FIG. 3 represents a metal ring used to flexibly fasten FIG. 1 to FIG. 2.

FIG. 4 represents the combination of FIG. 1 and FIG. 2 with FIG. 3 in one piece.

FIG. 5 represents a swollen glow plug. See the measurements in FIG. 5-5.

FIG. 6 represents FIG. 4 and inside it FIG. 5.

FIG. 7 represents an internally threaded outside movable tube for mounting FIG. 6 inside it. The front portion of it is smooth while the rear portion is rough to facilitate the manual twisting. At the tube sides, there are two small openings, which form a hook entrance. See the measurements in FIG. 7-7.

FIG. 8 represents a hook arranged on FIG. 7 for stabilizing.

FIG. 9 represents the full figure for disengaging and removal tool with swollen glow plug inside it.

### DETAILED DESCRIPTION OF THE INVENTION

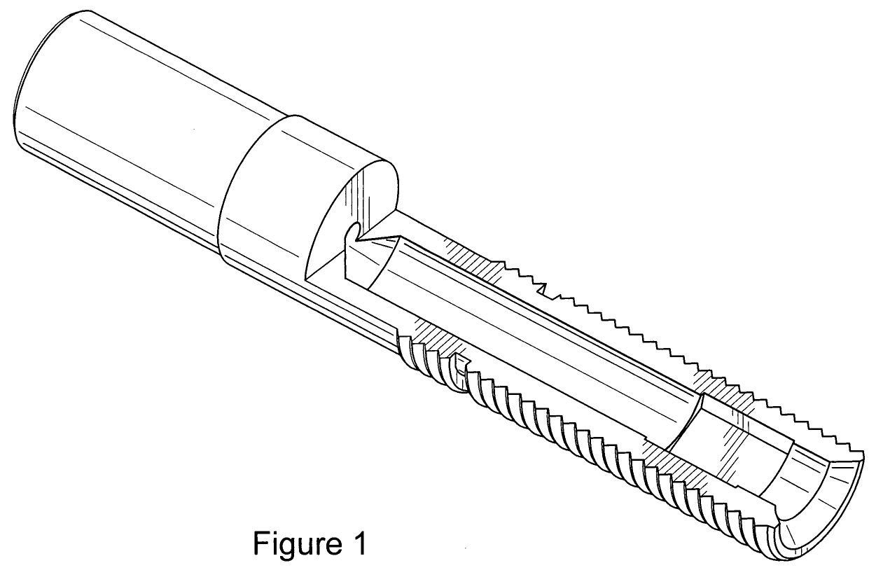

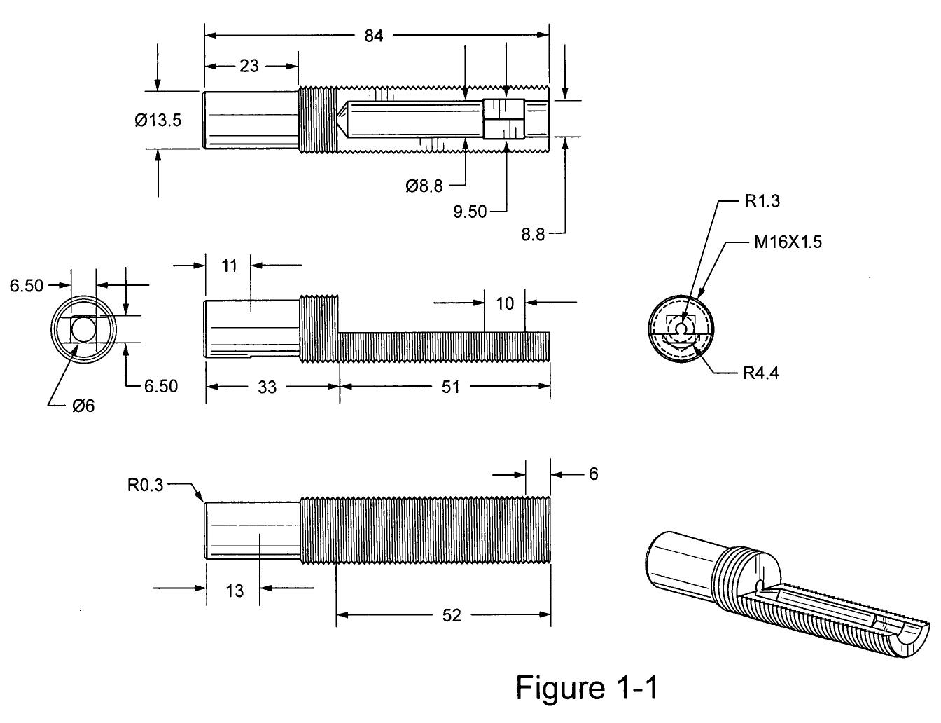

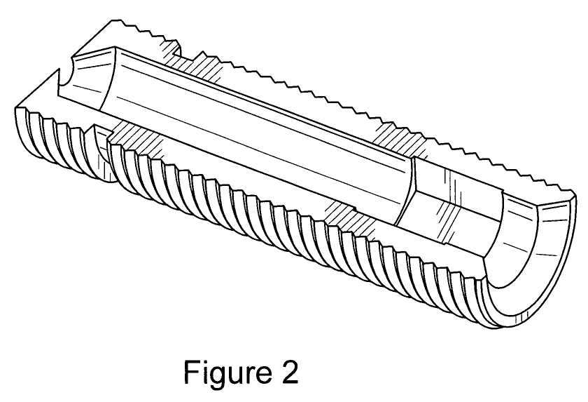

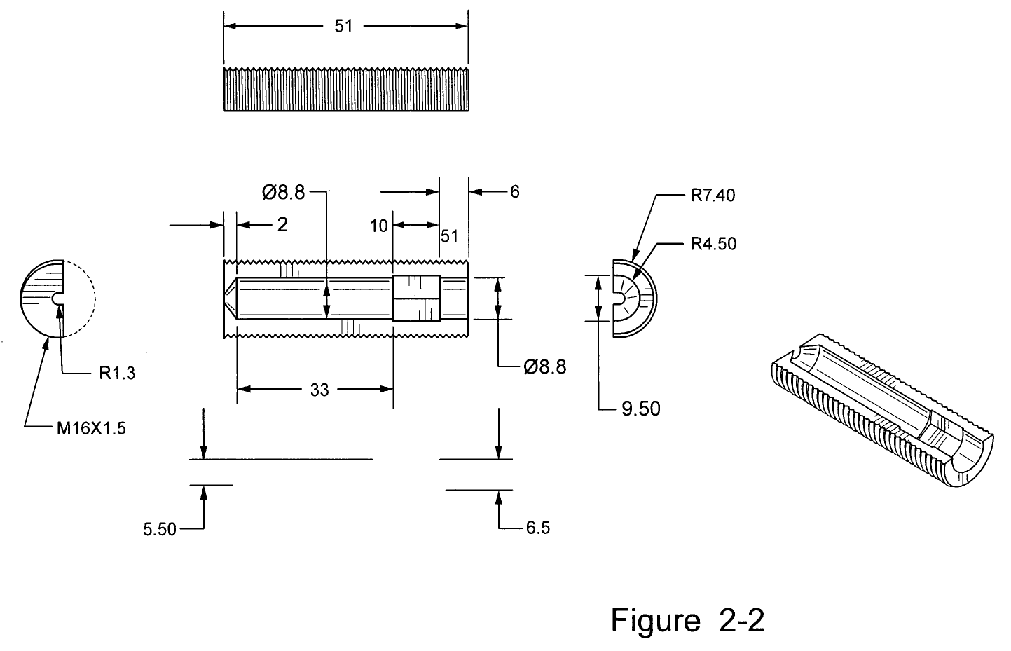

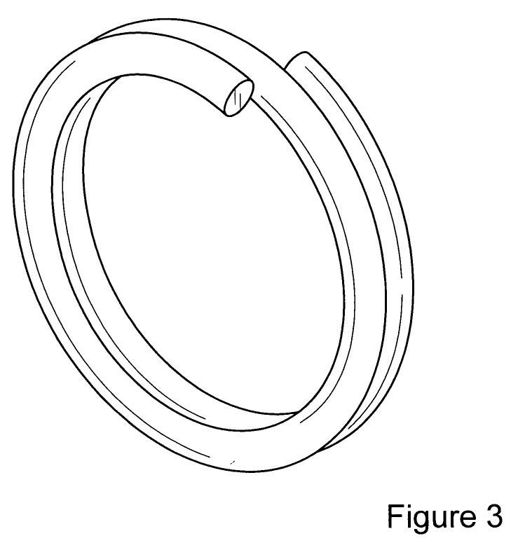

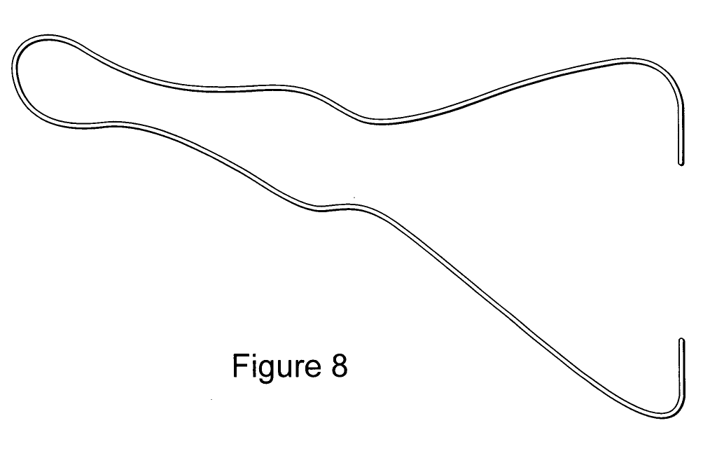

It will be described in the following and in conjunction with the illustrative drawings shown in FIGS. 1-9 how the new tool carries out the disengagement and removal process for swollen glow plug.

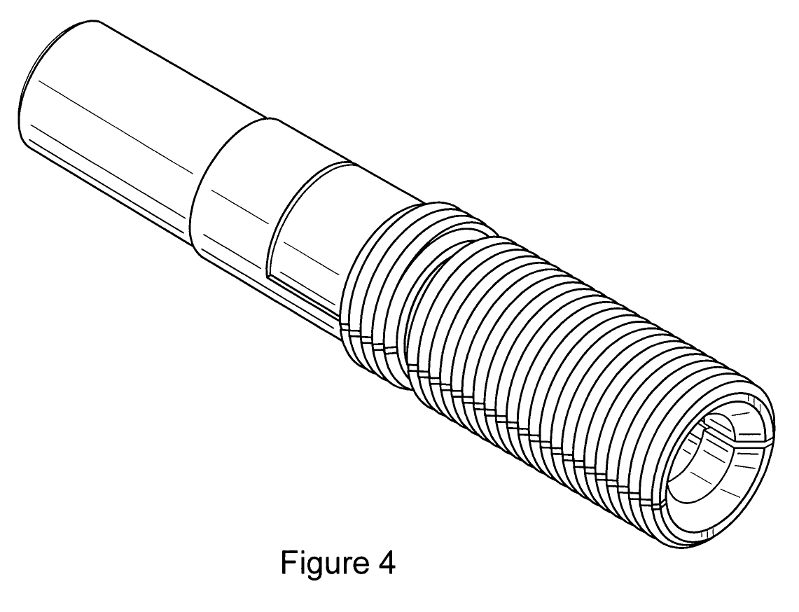

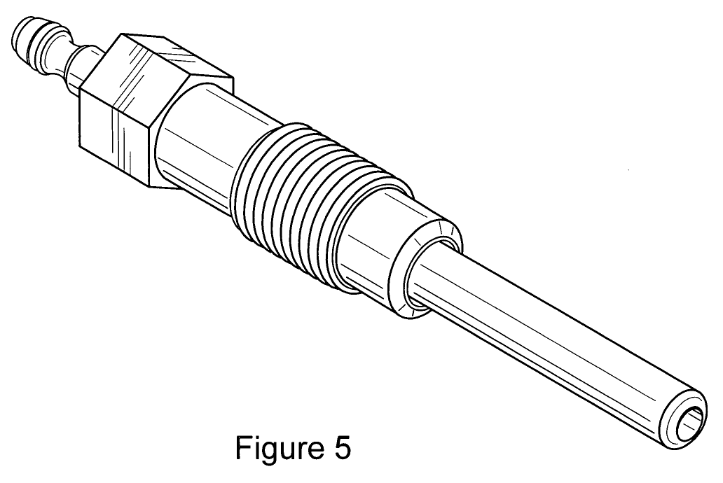

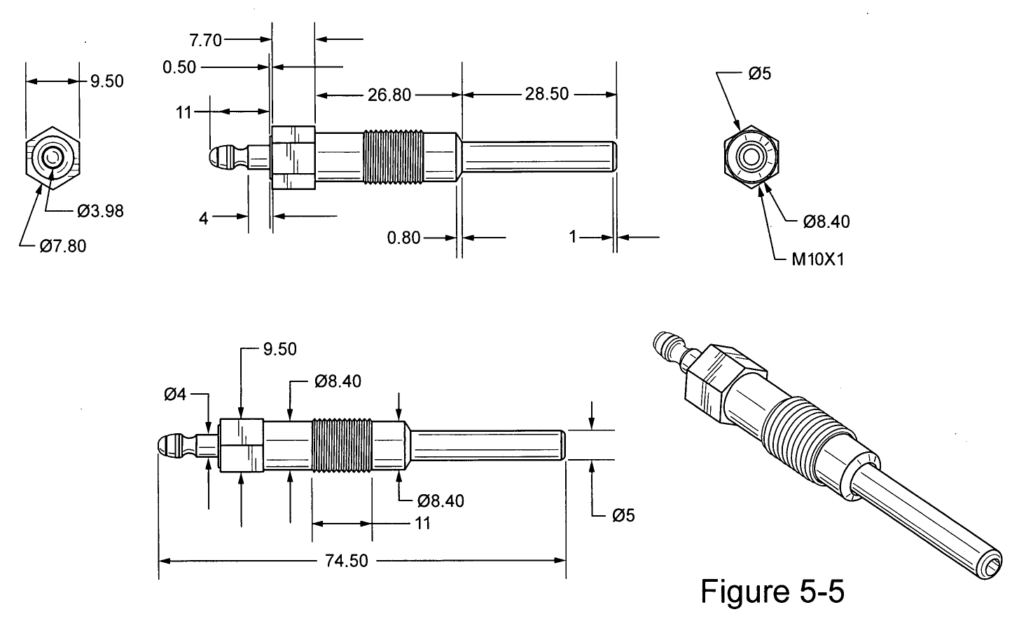

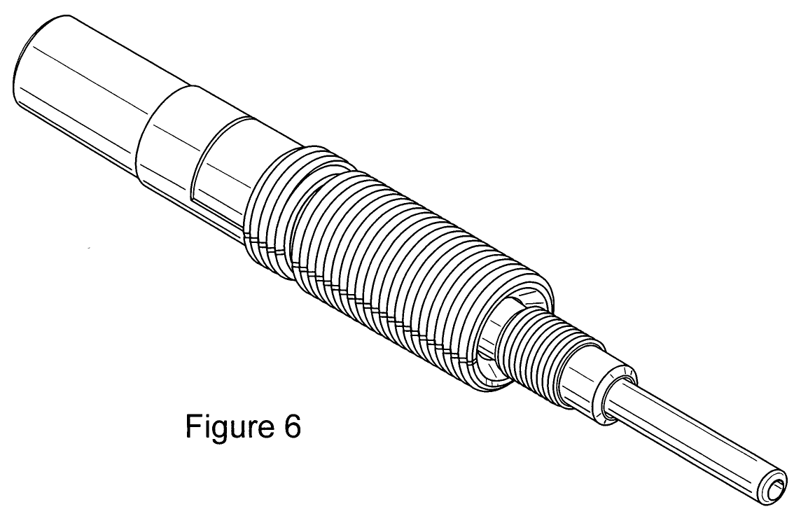

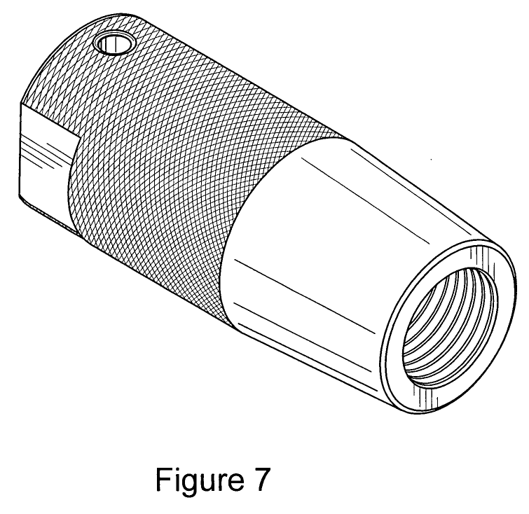

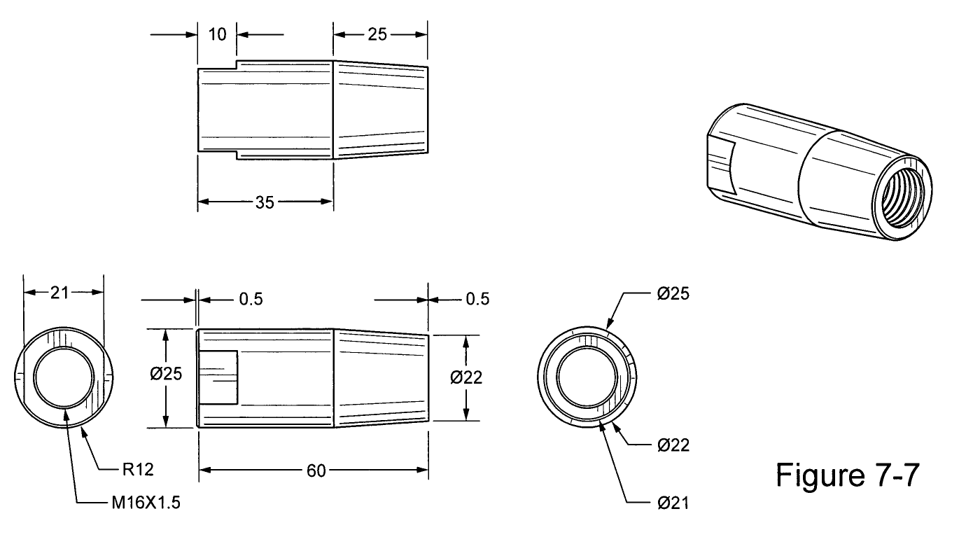

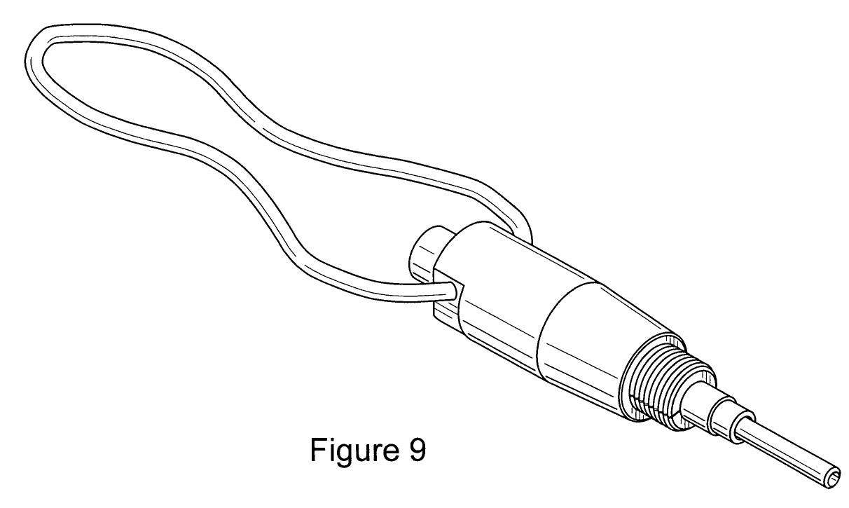

When the swollen glow plug is disengaged from the engine body, FIG. 4 and FIG. 5 are fastened to form one piece as shown in FIG. 6. Subsequently FIG. 7 is put inside FIG. 6 then FIG. 7 is manually twisted clockwise while stabilizing FIG. 6 until the engine is contacted at the end of twisting process as shown in FIG. 9. Then FIG. 6 is twisted anticlockwise through the automatic switch while stabilizing FIG. 7 with the hook. Thus the swollen glow plug is gradually withdrawn out of the body of the engine in a short time without being exposed to the risk of breakage.

1. A main cylindrical object having an externally threaded front portion and L-shaped cut. The edge of the front portion is cut out in V-shape. The inside of it is hollowed in a form similar to that of the glow plug to fasten it. There is also a semi-circular cutting in the externally threaded portion to fasten a metal ring. There is an opening at the rear portion of the figure to mount an automatic switch for engaging and disengaging process.

2. An externally threaded cylindrical object complementary to the main portion placed on the L-shaped portion. The edge of the front portion is cut out in V-shape. The inside of it is hollowed in the form of the glow plug to mount it. There is also a semi-circular cutting in the externally threaded portion to fasten a metal ring.

3. (canceled)

4. An internally threaded outside movable tube having a smooth front portion and a rough rear portion to facilitate the manual twisting. At the tube sides, there are two small openings, which form a hook entrance.

5. (canceled)

6. A securing metal ring.

7. A hook.
